(19) United States
(12) Patent Application Publication
(10) Pub. No.: US 2019/0304405 A1
(43) Pub. Date: Oct. 3, 2019

(54) PROCESSING METHOD AND ELECTRONIC DEVICE THEREOF

(71) Applicant: Lenovo (Beijing) Co., Ltd., Beijing (CN)

(72) Inventors: Jun SHI, Beijing (CN); Cheng CHANG, Beijing (CN); Yong TAN, Beijing (CN)

(21) Appl. No.: 16/370,978

(22) Filed: Mar. 30, 2019

(30) Foreign Application Priority Data
Mar. 30, 2018 (CN) 201810291165.7

(51) Int. Cl. G09G 5/10; G06F 3/0488; G06K 9/00; G06F 21/32

(52) U.S. Cl. CPC G09G 5/10; G06F 3/04883; G06K 9/00255; G06K 9/00013; G09G 2320/0686; G09G 2358/00; G09G 2354/00; G09G 2320/0626; G06F 21/32

(57) ABSTRACT

A processing method includes receiving a triggering instruction indicating a sliding operation via a touch display, and determining whether to illuminate the touch display from an unilluminated state based on biometric information in response to the triggering instruction being received.

### CROSS-REFERENCES TO RELATED APPLICATION

This application claims priority to Chinese Patent Application No. 201810291165.7, entitled “Processing Method and Electronic Device Thereof” filed on Mar. 30, 2018, the entire content of which is incorporated herein by reference.

### FIELD OF TECHNOLOGY

The present disclosure relates to the field of processing. More specifically, the present disclosure relates to a processing method and an electronic device thereof.

### BACKGROUND

In recent years, in order to unlock an electronic device with a slide cover by fingerprint or perform other processing operations on the electronic device, it is necessary to first perform a sliding operation to illuminate the display of the electronic device, then the electronic device may be unlocked using fingerprint. However, this process is complicated and therefore, lowers the user experience.

### BRIEF SUMMARY OF THE DISCLOSURE

One aspect of the present disclosure provides a processing method. The processing method includes receiving a triggering instruction indicating a sliding operation via a touch display, and determining whether to illuminate the touch display from an unilluminated state based on biometric information in response to the triggering instruction being received.

Another aspect of the present disclosure provides an electronic device having a touch display and a processor. The processor is configured to receive a triggering instruction indicating a sliding operation via the touch display, and determine whether to illuminate the touch display from an unilluminated state based on biometric information in response to the triggering instruction being received.

### BRIEF DESCRIPTION OF THE DRAWINGS

For a more complete understanding of the present disclosure, and the advantages thereof, reference is now made to the following descriptions to be taken in conjunction with the accompanying drawings. The accompanying drawings in the following description show merely some embodiments of the present invention, and a person of ordinary skill in the art may still derive other drawings from these accompanying drawings without creative efforts.

FIG. 1 is a flowchart illustrating a processing method according to an embodiment of the present disclosure;

FIG. 2 is a flowchart illustrating a processing method according to an embodiment of the present disclosure;

FIG. 3 is a flowchart illustrating a processing method according to an embodiment of the present disclosure;

FIG. 4 is a flowchart illustrating a processing method according to an embodiment of the present disclosure;

FIG. 5 is a flowchart illustrating a processing method according to an embodiment of the present disclosure; and

FIG. 6 is a schematic of an electronic device according to an embodiment of the present disclosure.

### DETAILED DESCRIPTION

Hereinafter, aspects, features, and embodiments of the present disclosure will be described with reference to the accompanying drawings. It should be understood that such description is illustrative only but is not intended to limit the scope of the present disclosure. In addition, it will be understood by those skilled in the art that various modifications in form and details may be made therein without departing from the spirit and scope of the present disclosure.

Features and aspects of the present disclosure will become apparent with reference to the accompanying drawings and non-limiting examples describing various embodiments of the present disclosure.

It will also be appreciated that although the present disclosure has been described with reference to some specific examples, equivalents of the present disclosure can be achieved by those skilled in the art. These equivalents having features claimed in the present disclosure should fall within the scope of protection defined hereinafter.

Hereinafter, embodiments of the present disclosure will be described with reference to the accompanying drawings. It should be understood that such description is illustrative only but is not intended to limit the scope of the present disclosure. In addition, in the following description, descriptions of well-known structures and techniques are omitted to avoid unnecessarily obscuring the concepts of the present disclosure. Therefore, specific structural and functional details disclosed herein are not intended to be limiting, but are merely used as a basis of the claims to teach those skilled in the art to use the present disclosure in various combinations.

The terms used herein are for the purpose of describing particular embodiments only but are not intended to limit the present disclosure. The words “a,” “an,” and “the” as used herein should also cover the meanings of “a plurality of” and “a variety of,” unless the context clearly dictates otherwise. In addition, the terms “comprising,” “including,” “containing,” and the like as used herein indicate the presence of the features, steps, operations and/or components, but do not preclude the presence or addition of one or more other features, steps, operations, or components.

The phrases “in an embodiment,” “in another embodiment,” or “in other embodiments” may refer to the same or different embodiments accordingly to the present disclosure.

The accompanying drawings illustrating embodiments of the present disclosure along with the summary of disclosure provided above and the detailed description provided below serve to explain the concepts of the present disclosure.

An embodiment of the present disclosure provides a processing method. The processing method includes determining whether to illuminate a touch display from an unilluminated state based on biometric information in response to a triggering instruction being received, where the triggering instruction may be the sliding operation of the touch display relative to a main body.

The processing method provided in the present disclosure may be applied to an electronic device, and the electronic device may be an electronic device with a display and a main body, where the display may slide relative to the main body.

More specifically, the display may slide up, down, right, and left relative to the main body such that the main body that may overlap with the display may be exposed. In one embodiment of the present disclosure, the display may slide in one direction relative to the main body, or, the display may slide in two directions relative to the main body in one dimension, or the display may slide in four directions relative to the main body in two dimensions. In the embodiment of the present disclosure, regardless of the sliding operation of the display, the display may automatically return to its original position relative to the main body after the external force is removed, or, the display may maintain its position after the sliding operation after the external force is remove, and an external force may be required to return the display to its original state before the sliding operation.

Further, the main body may include at least one camera, and the lens of the camera may face the display, therefore, if the display does not slide relative to the main body, the lens of the camera may be blocked, and if the display slides relative to the main body, the lends of the camera may be exposed.

Further, the biometric information may be collected by a biometric sensor, which may be a fingerprint sensor or a camera (for example, to collect a human face, an iris, or an outline of a human face). The fingerprint sensor in the embodiment of the present disclosure may be mounted on the back surface of the display, which may move or slide with the display relative to the main body, and a collection area of the fingerprint sensor may be a portion in the display area of the display. In another embodiment of the present disclosure, the fingerprint sensor may be disposed within the main body, the collection area of the fingerprint sensor may be a portion of the back surface of the main body, or a portion of the side surface of the main body. The camera in the embodiments of the present disclosure may be disposed within the main body. If the display slides relative to the main body, the lens of the camera may be exposed.

Further, the triggering instruction may be an indication that the display has slid relative to the main body. At this point, whether the display was slid relative to the main body to expose the main body that may overlap with the display, or to overlap the exposed main body with the display, all of which may be considered as the sliding operation of the display relative to the main body, and may be recognized as the triggering instruction.

Further, for determining whether to illuminate the display based on biometric information, the biometric information may be collected while the trigger instruction is received, or it may be collected within a predetermined amount of time before the triggering instruction is received.

Biometric information is the information collected by the biometric sensor. For example, the parameters corresponding to the sensing component of the fingerprint sensor will be different based on whether a finger is placed on the collection area of the fingerprint sensor or not. Therefore, determining whether to illuminate the display based on biometric information, using the fingerprint sensor as an example, may be the determination of whether a finger is placed on the collection area or not, that is, using the parameters of the sensing component of the fingerprint sensor to determine whether there is a finger or not. Similarly, when it comes to face recognition, a face recognition camera or a set of recognition devices having a camera (structured light emitter, infrared light emitter, infrared light receiver, etc.) may determine whether its corresponding collection area has a face or not.

If a triggering instruction is received, e.g., the display has slid relative to the main body, and the biometric information satisfies the predetermined condition, then the display may be illuminated. However, if one of the abovementioned conditions is not satisfied, then the display may remain in the unilluminated state, that is, the electronic device does not need to carry out additional action to maintain the display in the unilluminated state.

Furthermore, if a triggering instruction is received, and the biometric sensor used to collect the biometric information is detected to be in a non-working state, then the display may remain in the unilluminated state.

More specifically, if the biometric sensor is in the non-working state, it may not be able to collect biometric information, and the display may not be illuminated based on the current biometric information, hence, the display may remain in the unilluminated state. In other words, under the current condition, the sliding operation of the display relative to the main body will not illuminate the display, thereby reducing power consumption.

The embodiments of the present disclosure provide a processing method that may be used to determine whether to illuminate a display in an unilluminated state based on biometric information in response to a triggering instruction being received, where the triggering instruction may be the sliding operation of the display relative to a main body. When the triggering instruction is received, e.g., the display has slid relative to the main body, the biometric information may be used to determine whether to illuminate the display, so that when the display is illuminated, not only the triggering instruction is required, but the biometric information is also required. This process not only ensures the security of the information stored in the electronic device, but also simplifies the use of the electronic device, thereby improving the user experience.

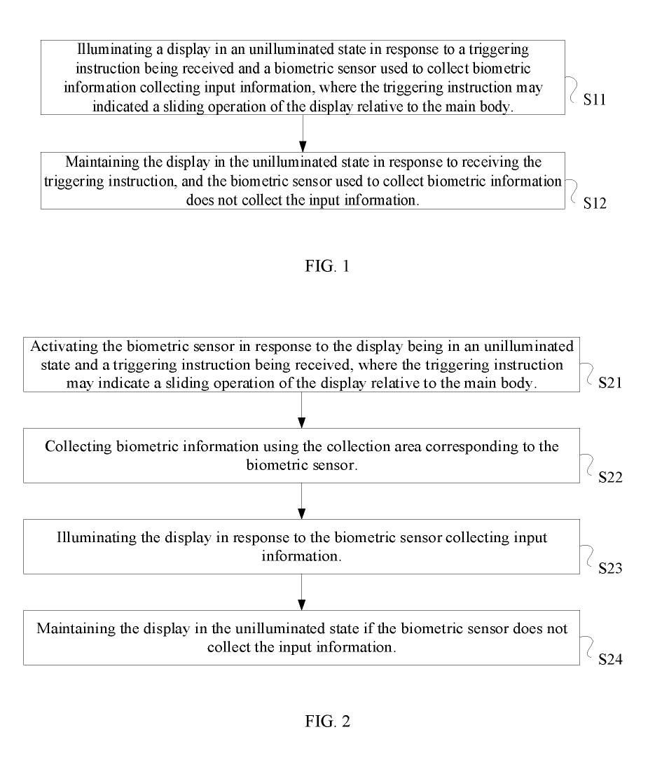

FIG. 1 is a flowchart illustrating a processing method according to an embodiment of the present disclosure. The processing method is described in more detail below.

S11, illuminating a display in an unilluminated state in response to a triggering instruction being received and a biometric sensor used to collect biometric information collecting input information, where the triggering instruction may indicate a sliding operation of the display relative to the main body.

S12, maintaining the display in the unilluminated state in response to receiving the triggering instruction, and the biometric sensor used to collect biometric information does not collect the input information.

In some embodiments, determining whether to illuminate the display based on biometric information may specifically include: if the biometric sensor collects the input information, illuminating the display; if the biometric information does not collect the input, the display may remain in the unilluminated state, that is, the electronic device does not need to carry out additional action to maintain the display in the unilluminated state. In other words, if the collection area of the biometric sensor does not collect information indicating the presence of an object with biometric information (for example, the absence of a finger or a human face), the finger used to apply the external force to perform the sliding operation of the display relative to the main body may not be in the collection area of the biometric sensor, so the electronic device will not carry out additional action such that the display is maintained in the unilluminated state; or the human face may not appear in the collection area of the biometric sensor while the external force is being applied to perform the sliding operation of the display relative to the main body, so the electronic device will not carry out additional action such that the display is maintained in the unilluminated state.

Further, the biometric sensor collecting the biometric information may include, for example, the camera collecting an image with a human face (that is, a human face is in the collection area of the camera), or the sensing component of the fingerprint sensor collecting parameters indicating the information collected is fingerprint information (that is, a finger is in the collection area of the fingerprint sensor)

Further, determining whether to illuminate the display may be done when the triggering instruction is received, and be based on whether the biometric sensor collects the biometric information or not, regardless whether the biometric information collected matches predetermined biometric information of the electronic device's user (for example, matching the electronic device user's fingerprint or face feature).

More specifically, receiving the triggering instruction and collecting the biometric information may be performed simultaneously or non-simultaneously.

If receiving the triggering instruction and collecting the biometric information are performed simultaneously, then the biometric information may be collected while the display is slid.

For example, if the biometric sensor is a fingerprint sensor, placing a finger in an area corresponding to the collection area of the fingerprint sensor to slide the display (in the embodiment where the fingerprint sensor may be mounted on the back of the display, and its collection area corresponds to a portion of the display area of the display) will allow the electronic device to receive the triggering instruction and collecting the biometric information at the same time.

Further, if receiving the triggering instruction and collecting the biometric information are performed non-simultaneously, the triggering instruction may be received first, then the biometric information is collected; or the biometric information may be collected first, then the triggering instruction is received.

Further, the display may be illuminated in response to the trigger instruction being received and the biometric information being collected. In some embodiments, the method may further include determining whether the biometric information collected by the biometric sensor matches pre-stored unlock information (e.g., the pre-stored biometric information of the owner of the electronic device). If it matches, the display may be unlocked; and if it does not match, then the display may be illuminated without being unlocked.

Regarding the pre-stored unlock information, if the biometric sensor is a fingerprint sensor, the pre-stored unlock information may be the pre-stored fingerprint information, e.g., the fingerprint information of a user who may have the access to unlock the electronic device. In some embodiments, the pre-stored unlock information may include the fingerprint information of a plurality of users, a plurality of pieces of fingerprint information of one user, or a plurality of pieces of fingerprint information of each user of the plurality of users.

In some embodiments, if the biometric sensor is a camera, the pre-stored unlock information may be the pre-stored face information, e.g., the face information of a user who may have the access to unlock the electronic device. In addition, the pre-stored unlock information may be other information of a user who may have the access to unlock the electronic device, such as the eye information, the iris information, or the face outline information.

In one embodiment, determining whether the biometric information collected by the biometric sensor matches the pre-stored unlock information may be the determination of whether the biometric information is successfully recognized, such as whether the fingerprint is successfully recognized, or whether the image information is successfully recognized, etc.

More specifically, in one embodiment, receiving the triggering instruction and collecting the biometric information are performed simultaneously. In this process, it only takes one step to illuminate the display, and no additional step may be required to unlock the display as the biometric information collected by the biometric sensor may be sufficient to determine whether the display may be unlocked or not. If the display is unlocked, then the illumination and the unlocking of the display may be accomplished in one step.

In another embodiment of the present disclosure, the display may slide relative to the main body. More specifically, the display may slide up or down relative to the main body. Further, a function of the electronic device may be quickly activated by sliding the display while the display is off. For example, if the display slides down relative to the main body while the collection area corresponding to the biometric sensor does not have an object with biometric information in it, or the biometric sensor is in a non-working state, then a camera module (the back camera disposed at the main body, or the front camera disposed at the main body) may be quickly activated to capture and store an image while the display of the electronic device is still off (that is, the blank display state). Further, if the display slides up relative to the main body while the collection area corresponding to the biometric sensor does not have an object with biometric information in it, or the biometric sensor is in a non-working state, then a back flash may be quickly activated to be used as a flashlight while the display of the electronic is still off (that is, the blank display state).

In another embodiment of the present disclosure, the display may slide relative to the main body. More specifically, the display may slide up or down relative to the main body. If the electronic device is in a unlocked working state, then sliding the display may activate an application of the electronic device. For example, if the display slides down relative to the main body, then a first application, such as an image capturing application, may be activated, where the image capturing application may activate the camera module, capture image, store image, etc. If the display of the electronic device has been in the illuminated state due to user controls and operations, sliding the display up relative to the main body may activate a second application, such as a chatting application, phone application, etc.

The embodiments of the present disclosure provide a processing method that may be used to determine whether to illuminate a display in an unilluminated state based on biometric information in response to a triggering instruction being received, where the triggering instruction may be the sliding operation of the display relative to a main body. When the triggering instruction is received, e.g., the display has slid relative to the main body, the biometric information may be used to determine whether to illuminate the display. As such, to illuminate the display, not only the triggering instruction is required, but the biometric information is also required. This process not only ensures the security of the information stored in the electronic device, but also simplifies the use of the electronic device, thereby improving the user experience.

FIG. 2 is a flowchart illustrating a processing method according to an embodiment of the present disclosure. The processing method is described in more detail below.

S21, activating the biometric sensor in response to the display being in an unilluminated state and a triggering instruction being received, where the triggering instruction may indicate a sliding operation of the display relative to the main body.

S22, collecting biometric information using the collection area corresponding to the biometric sensor.

When the display is in an unilluminated state, if a triggering instruction is received, e.g., the display has slid relative to the main body, the biometric sensor may be activated, that is, activating the biometric sensor by the triggering instruction. Subsequently, the biometric sensor may be used to collect biometric information. If the biometric information is collected, the display may be illuminated. On the other hand, if the biometric information is not collected, the display may remain in the unilluminated state. For example, the biometric sensor may be activated when the display has slid relative to the main body. At this point, the display is still in the unilluminated state and the biometric information is not collected during the sliding operation to avoid the problem of high power consumption caused by the biometric sensor being constantly in the activated state.

If the display is a full display, e.g., the display may have a display area with no other sensors (such as a camera, which may be disposed at the main body), and a triggering instruction is received, e.g., the display has slid relative to the main body, the lens of the camera, which is the biometric sensor may be exposed. With the sliding operation of the display relative to the main body, the biometric sensor may be activated to avoid the problem of high power consumption caused by the biometric sensor being constantly in the activated state.

Further, when the triggering instruction is received, e.g., the display has slid relative to the main body, the biometric sensor may be activated and start to collect biometric information. If biometric information is collected, the display may be illuminated; if biometric information is not collected, the display may remain unilluminated. Furthermore, if biometric information is collected, the display may be illuminated, at the same time, the biometric information collected may be used to match the pre-store unlock information, If there is a match, the display may be unlocked, otherwise, the display may be illuminated without being unlocked.

S23, illuminating the display in response to the biometric sensor collecting input information.

S24, maintaining the display in the unilluminated state if the biometric sensor does not collect the input information.

The embodiments of the present disclosure provide a processing method that may be used to determine whether to illuminate a display based on biometric information in response to the display being in an unilluminated state and a triggering instruction being received, where the triggering instruction may indicate a sliding operation of the display relative to a main body. When the triggering instruction is received, e.g., the display has slid relative to the main body, the biometric information may be used to determine whether to illuminate the display. As such, to illuminate the display, not only the triggering instruction is required, but the biometric information is also required. This process not only ensures the security of the information stored in the electronic device, but also simplifies the use of the electronic device, thereby improving the user experience.

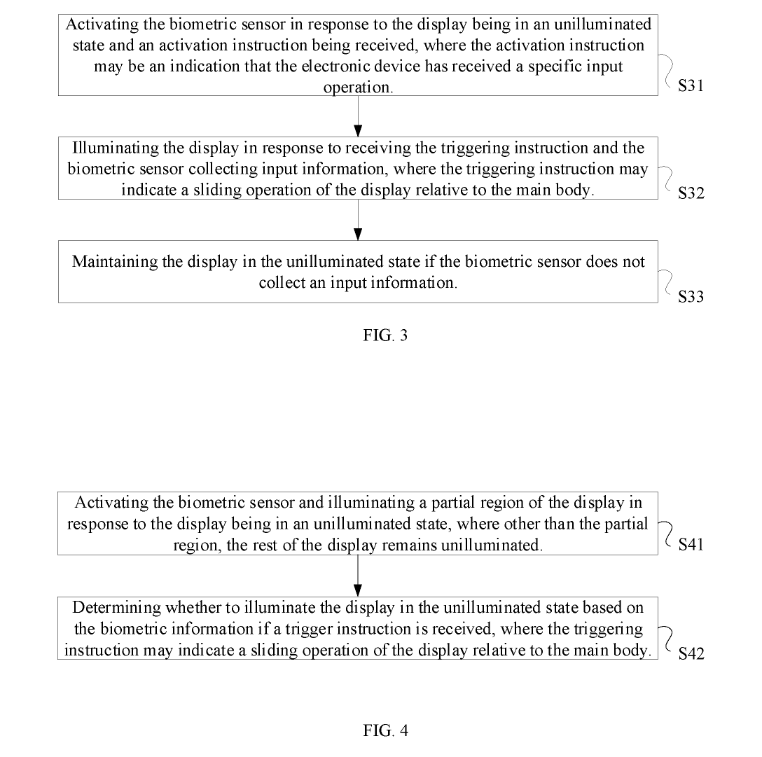

FIG. 3 is a flowchart illustrating a processing method according to an embodiment of the present disclosure. The processing method is described in more detail below.

S31, activating the biometric sensor in response to the display being in an unilluminated state and an activation instruction being received, where the activation instruction may be an indication that the electronic device has received a specific input operation.

S32, illuminating the display in response to receiving the triggering instruction and the biometric sensor collecting input information, where the triggering instruction may indicate a sliding operation of the display relative to the main body.

In one embodiment, the activation instruction is first received to activate the biometric sensor. At this point, the biometric sensor is in an activated state, but it may not collect information. Before the activation instruction is received, the biometric sensor may remain in a sleep or shut off state, until it is activated by the activation instruction. When the triggering instruction is received, the biometric sensor in the activated state may start to collect the biometric information. For example, the activation instruction is first received to activate the biometric sensor. Subsequently, when the display has slid relative to the main body, the biometric sensor may start to collect biometric information. If biometric information is collected, the display may be illuminated. On the other hand, if biometric information is not collected, the display may remain unilluminated.

Further, the activation instruction may be a detection signal transmitted by a gyro sensor.

The gyro sensor in the electronic device may be constantly in an activated state. If the detection signal of the gyro sensor indicates that the electronic device has been picked up or its geospatial state has changed, an activation instruction may be transmitted to activate the biometric sensor, so that the biometric information may be collected by the activated biometric sensor when the electronic device receives the triggering instruction. If the biometric information is collected, the display may be illuminated, and if the biometric sensor does not collect the biometric information, the display may remain unilluminated.

In the present embodiment, the biometric sensor may be activated when the activation instruction is received. Before the activation instruction is received, the biometric sensor may remain in a sleep or shut off state, and the gyro sensor may be constantly in an activated state. Since the power consumption of the gyro sensor in the activated state is lower than the power consumption of the biometric sensor in the activated state, the arrangement of the present embodiment may lower the power consumption of the biometric sensor being in a constant activated state.

Further, the activation instruction may be a detection signal transmitted by a P-sensor, or a detection signal transmitted by an acceleration sensor instead of the detection signal transmitted by the gyro sensor.

In some embodiments, the power consumption of the P-sensor may be calculated as follow:

1.8V*0.03 mA+3.3V*0.0007 mA=0.056 mW

In some embodiments, an example power consumption look-up table of the acceleration sensor is provided in Table 1:

TABLE 1

| Symbol | Parameter | Test conditions | Min. | Typ.⁽¹⁾ | Max. | Unit |
|---|---|---|---|---|---|---|
| Vdd | Supply voltage | | 1.71 | 1.8 | 3.6 | V |
| Vdd_IO | Power supply for I/O | | 1.62 | | Vdd + 0.1 | V |
| IddHP | Gyroscope and accelerometer in | up to ODR = 1.6 kHz | | 1.25 | | mA |
| | high-performance mode | | | | | |
| IddNM | Gyroscope and accelerometer in | ODR = 208 Hz | | 0.9 | | mA |
| | normal mode | | | | | |
| IddLP | Gyroscope and accelerometer in | ODR = 13 Hz | | 0.42 | | mA |
| | low-power mode | | | | | |
| LA_IddHP | Accelerometer current consumption | up to ODR = 1.6 kHz | | 240 | | μA |
| | in high-performance mode | | | | | |
| LA_IddNM | Accelerometer current consumption | ODR = 104 Hz | | 70 | | μA |
| | in normal mode | | | | | |
| LA_IddLM | Accelerometer current consumption | ODR = 13 Hz | | 24 | | μA |
| | in low-power mode | | | | | |
| IddPD | Gyroscope and accelerometer in | | | 6 | | μA |
| | power down | | | | | |
| Top | Operating temperature range | | −40 | | +85 | ° C. |

The power consumption of the acceleration sensor may be calculated as follow:

1.8V*0.024 mA=0.043 mW

The power consumption of the fingerprint sensor may be calculated as follow:

1.8V*1.2 mA=2.16 mW

Comparing the above power consumption values, it is clear that both the power consumptions of the P-sensor and the acceleration sensor are lower than the power consumption of the fingerprint sensor. Since the power consumption of the P-sensor, acceleration sensor, or the gyro sensor in the constant activated state is lower than the power consumption of the fingerprint sensor in the constant activated state, in some embodiments, the P-sensor, acceleration sensor, or the gyro sensor is used to transmit the activation instruction over the fingerprint sensor.

S33, maintaining the display in the unilluminated state if the biometric sensor does not collect the input information.

The embodiments of the present disclosure provide a processing method that may be used to determine whether to illuminate a display based on biometric information in response to the display being in an unilluminated state and a triggering instruction being received, where the triggering instruction may indicate the sliding operation of the display relative to a main body. When the triggering instruction is received, e.g., the display has slid relative to the main body, the biometric information may be used to determine whether to illuminate the display. As such, to illuminate the display, not only the triggering instruction is required, but the biometric information is also required. This process not only ensures the security of the information stored in the electronic device, but also simplifies the use of the electronic device, thereby improving the user experience.

FIG. 4 is a flowchart illustrating a processing method according to an embodiment of the present disclosure. The processing method is described in more detail below.

S41, activating the biometric sensor and illuminating a partial region of the display in response to the display being in an unilluminated state, where other than the partial region, the rest of the display remains unilluminated.

S42, determining whether to illuminate the display in the unilluminated state based on the biometric information if a trigger instruction is received, where the triggering instruction may indicate a sliding operation of the display relative to the main body.

The biometric sensor may be located under the display, and the collection area of the biometric sensor may correspond to a partial region of the display, e.g., the biometric sensor may be disposed under the display, and a region on the display that corresponds to the biometric sensor may be the partial region.

The partial region may be a partial area on the display that corresponds to one or more fingerprint sensors. If the area of a set of sensing units (having one or more sensing units) that corresponds to a fingerprint sensor is limited, then the partial region may be small and the sensor may be modified to correspond to a plurality of sensing units, so the partial region may be increased. Further, a plurality of fingerprint sensors may be used to increase the partial region.

In the present embodiment, when the biometric sensor is activated, the partial region on the display may be illuminated, e.g., the area on the display where the biometric sensor for detecting the input signal may be illuminated, and the rest of the display other than the partial region may remain unilluminated, that is, not the entire display may be illuminated. When illuminating the partial region, the display will change from an unilluminated state to a partially illuminated state, and the user may be prompted to perform the fingerprint recognition at the partial region. The illumination of the partial region serves the purpose of reminding the user the location of the biometric sensor and to perform the fingerprint recognition, hence, avoiding the problem of not knowing the location to perform the fingerprint recognition, which greatly enhances the user experience.

Further, the partial region may not be illuminated after the biometric sensor is activated as long as the user is aware of the specific area where the biometric sensor is disposed under the display. Without illuminating the display, the privacy of the user using the electronic device is protected, and the user experience is improved.

The embodiments of the present disclosure provide a processing method that may be used to determine whether to illuminate a display based on biometric information in response to the display being in an unilluminated state and a triggering instruction being received, where the triggering instruction may indicate a sliding operation of the display relative to a main body. When the triggering instruction is received, e.g., the display has slid relative to the main body, the biometric information may be used to determine whether to illuminate the display. As such, to illuminate the display, not only the triggering instruction is required, but the biometric information is also required. This process not only ensures the security of the information stored in the electronic device, but also simplifies the use of the electronic device, thereby improving the user experience.

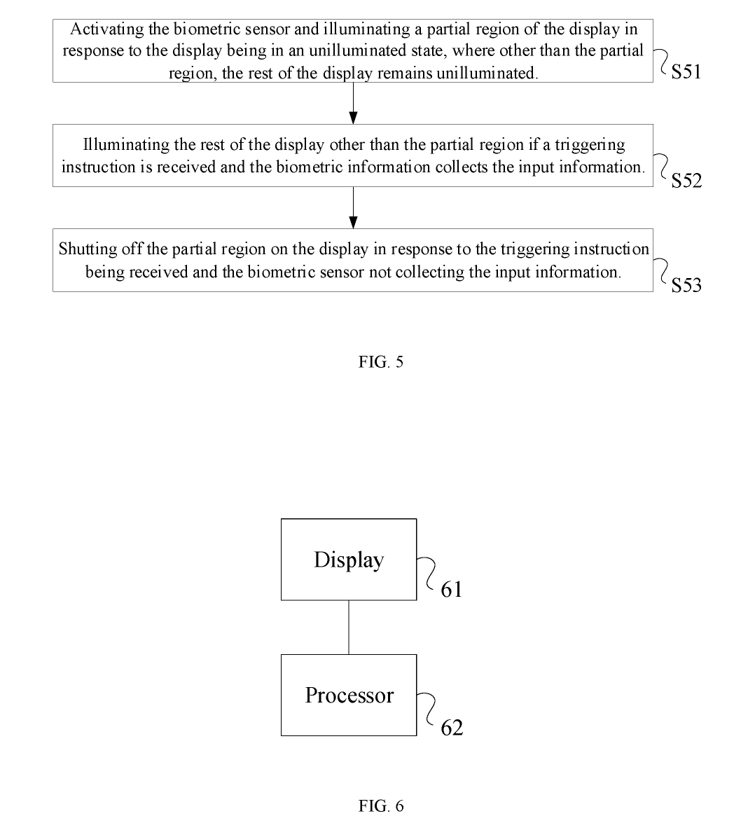

FIG. 5 is a flowchart illustrating a processing method according to an embodiment of the present disclosure. The processing method is described in more detail below.

S51, activating the biometric sensor and illuminating a partial region of the display in response to the display being in an unilluminated state, where other than the partial region, the rest of the display remains unilluminated.

S52, illuminating the rest of the display other than the partial region if a triggering instruction is received and the biometric information collects the input information.

S53, shutting off the partial region on the display in response to the triggering instruction being received and the biometric sensor not collecting the input information.

To serve the purpose of reminding users the area on the display where information should be entered, if the biometric sensor is activated, regardless of when the biometric sensor is activated, or whether the biometric sensor is activated by a trigger instruction or an activation instruction, as soon as it is activated, the partial region on the display may be illuminated, so the user clearly knows the area on the display where information should be entered when entering the information.

If the trigger instruction is received and the biometric sensor collects the input information, the area on the display other than the partial region may be illuminated. At this time, since the partial region is illuminated, and the area on the display other than the partial region is also illuminated, then the entire display may be illuminated, that is, the purpose of illuminating the display is achieved.

If the triggering instruction is received and the biometric sensor does not collect the input information, the partial region on the display may be shut off. When the biometric sensor is activated, a partial area on the display corresponding to the biometric sensor may be activated so the user may conveniently enter the biometric information in the partial area on the display, thereby achieving the purpose of illuminating the entire display. However, if the biometric sensor does not collect the input information, then the entire display should not be illuminated. Therefore, at this point, the area on the display other than the partial region may remain unilluminated, and the partial area that is illuminated may be shut off, so the entire display may remain unilluminated.

Further, the display may perform a sliding operation relative to the main body, and the sliding operation may include the display sliding up relative to the main body, and the display sliding down relative to the main body.

Furthermore, the partial region may be a partial area on the display that corresponds to a fingerprint sensor having two or more fingerprint recognition chips.

More specifically, different sliding operations and in different parts of the partial region may corresponds to different control instructions. For example, the biometric sensor may be activated and the partial region may be illuminated, if a first triggering instruction is received, e.g. the display has slid up relative to the main body, and the biometric sensor detects an input signal in a first location of the partial region, then the electronic device may execute a third operation, which not only include illuminating the rest of display other than the partial region, but also include activating a third application, such as activating WeChat. In another example, the biometric sensor may be activated and the partial region may be illuminated, if a second triggering instruction is received, e.g., the display has slid up relative to the main body, and the biometric sensor detects an input signal in a second location of the partial region, then the electronic device may execute a fourth operation, which not only include illuminating the rest of display other than the partial region, but also include activating a fourth application, such as activating QQ.

Further, in yet another example, the biometric sensor may be activated and the partial region may be illuminated, if a third triggering instruction is received, e.g., the display has slid down relative to the main body, and the biometric sensor detects an input signal in the first location of the partial region, then the electronic device may execute a fifth operation, which not only include illuminating the rest of display other than the partial region, but also include activating a fifth application, such as activating a music player. In another example, the biometric sensor may be activated and the partial region may be illuminated, if the first triggering instruction is received, e.g., the display has slid down relative to the main body, and the biometric sensor detects an input signal in the second location of the partial region, then the electronic device may execute a sixth operation, which not only include illuminating the rest of display other than the partial region, but also include activating a sixth application, such as activating a video player.

As mentioned above, different sliding operations and the input signal detected in different parts of the partial region may correspond to different control instructions. The examples provided above are merely for illustrative purposes, and other examples may also be included, which are not specifically limited herein.

The embodiments of the present disclosure provide a processing method that may be used to determine whether to illuminate a display based on biometric information in response to the display being in an unilluminated state and a triggering instruction being received, where the triggering instruction may indicate a sliding operation of the display relative to a main body. When the triggering instruction is received, e.g., the display has slid relative to the main body, the biometric information may be used to determine whether to illuminate the display. As such, to illuminate the display, not only the triggering instruction is required, but the biometric information is also required. This process not only ensures the security of the information stored in the electronic device, but also simplifies the use of the electronic device, thereby improving the user experience.

FIG. 6 is a schematic of an electronic device according to an embodiment of the present disclosure. The electronic device includes a display 61 and a processor 62.

When the display 61 is in an unilluminated state, if a triggering instruction is received, the processor 62 may determine whether to illuminate the display 61 in the unilluminated state based on biometric information, where the triggering instruction may indicate a sliding operation of display 61 relative to the main body.

The electronic device may be an electronic device with a display and a main body, where the display may slide relative to the main body.

More specifically, the display may slide up, down, right, and left relative to the main body such that the main body that may overlap with the display may be exposed.

The biometric information may be collected by a biometric sensor, which may be disposed at the main body. More specifically, the biometric sensor may be disposed under the display and the collection area may be disposed on the display, such as a fingerprint sensor under the display as the under display fingerprint sensor in Samsung Galaxy S8.

Further, the biometric sensor may be disposed on the upper surface of the display. More specifically, the biometric sensor may be disposed above or under the display area of the display. For example, the front camera of a mobile phone may be disposed above the display area of the display and the fingerprint sensor of a tablet may be disposed under the display area of the display; or, when the display has slid relative to the main body, the biometric sensor disposed on the back of the display may be exposed.

Further, the biometric sensor may be disposed under the display, such as on the back of the display as the back camera of a mobile phone, or a fingerprint sensor on the back of the display.

Further, the biometric sensor may be disposed above the upper surface of the main body, such that when the display has slid relative to the main body, the biometric sensor disposed on the upper surface of the main body may be exposed.

Furthermore, the biometric sensor may be a fingerprint sensor, a camera, or other sensors, which is not specifically limited herein.

Further, the triggering instruction may be an indication that the display has slid relative to the main body. At this point, whether the display was slid relative to the main body to expose the main body that may overlap with the display, or to overlap the exposed main body with the display, all of which may be considered as the sliding operation of the display relative to the main body, and may be recognized as a triggering instruction.

Further, when determining whether to illuminate the display based on biometric information, the biometric information may be collected while the trigger instruction is received, or it may be collected within a predetermined amount of time before the triggering instruction is received.

If a triggering instruction is received, e.g., the display has slid relative to the main body, and the biometric information satisfies a predetermined condition, then the display may be illuminated. However, if one of the abovementioned conditions is not satisfied, then the display may remain in the unilluminated state.

Furthermore, if a triggering instruction is received and the biometric sensor used to collect the biometric information is detected to be in a non-working state, then the display may remain in the unilluminated state.

More specifically, if the biometric sensor is in a non-working state, it may not be able to collect biometric information, and the display may not be illuminated based on the current biometric information, hence, the display may remain the unilluminated state.

Further, if the triggering instruction is received and the biometric sensor is in a non-working state, detect if the biometric information is collected by the biometric sensor in a first time period prior to receiving the triggering instruction. If the biometric information is collected prior to the first time period, determine whether to illuminate the display in the unilluminated state based on the biometric information.

Determine whether to illuminate the display in the unilluminated state based on the biometric information may include: if the triggering instruction is received and the biometric sensor collects the input information, the display may be illuminated; and, if the triggering instruction is received and the biometric information does not collect the input information, the display may remain in the unilluminated state, where the input information may be data that indicate biometric information.

Determine whether to illuminate the display in the unilluminated state based on the biometric information may specifically include: if the biometric sensor collects the input information, the display may be illuminated; and, if the biometric information does not collect the input information, the display may remain in the unilluminated state.

The biometric sensor collecting the input information may be the biometric sensor collecting the biometric information, such as the camera collecting an image or the fingerprint sensor collecting the fingerprints that need to be recognized.

Further, determining whether to illuminate the display in the unilluminated state may be done when the triggering instruction is received, and determine whether the biometric sensor collects biometric information or not regardless whether the biometric information collected meet certain requirements.

More specifically, receiving the triggering instruction and collecting the biometric information may be performed simultaneously or non-simultaneously.

Further, if receiving the triggering instruction and collecting the biometric information are performed simultaneously, then the biometric information may be collected while the display is slid.

For example, if the biometric sensor is a fingerprint sensor, placing a finger in an area corresponding to the collection area of the fingerprint sensor to slide the display will allow the electronic device to receive the triggering instruction and collect the biometric information at the same time.

Further, if receiving the triggering instruction and collecting the biometric information are performed non-simultaneously, the triggering instruction may be received first, then the biometric information is collected; or ng the biometric information may be collected first, then the triggering instruction is received.

Further, the display may be illuminated in response to receiving the trigger instruction and collecting the biometric information. Furthermore, determine whether the biometric information collected by the biometric sensor matches pre-stored unlock information. If it matches, unlock the display; and, if it does not match, then illuminate the display without unlocking the display.

Regarding the pre-stored unlock information, if the biometric sensor is a fingerprint sensor, the pre-stored unlock information may be the pre-stored fingerprint information of a user who may have the access to unlock the electronic device. In some embodiments, the pre-stored unlock information may also include the fingerprint information of a plurality of users, a plurality of pieces of fingerprint information of one user, or a plurality of pieces of fingerprint information of each user of the plurality of users.

Furthermore, if the biometric sensor is a camera, the pre-stored unlock information may be the pre-stored face information of a user who may have the access to unlock the electronic device. In addition, the pre-stored unlock information may be other information of the user who may have the access to unlock the electronic device, such as the fingerprints information, the eye information, etc.

In one embodiment, determining whether the biometric information collected by the biometric sensor matches the pre-stored unlock information may be the determination of whether the biometric information is successfully recognized, such as whether the fingerprint is successfully recognized, or whether the image information is successfully recognized, etc.

More specifically, in one embodiment, receiving the triggering instruction and collecting the biometric information are performed simultaneously. In this process, it only takes one step to illuminate the display, and no additional step may be required to unlock the display as the biometric information collected by the biometric sensor may be sufficient to determine whether the display may be unlocked or not.

In one embodiment of the present disclosure, the display may slide relative to the main body, e.g., the display may slide up or down relative to the main body. More specifically, if the display slides up relative to the main body and the biometric sensor detects input information, the electronic device may execute a first operation. The first operation will not only illuminate the display, but will also activate a first application, such as activating an image capturing application. If the display slides down relative to the main body and the biometric sensor detects input information, the electronic device may execute a second operation. The second operation will not only illuminate the display, but will also activate a second application, such as activating a phone application.

Further, when the display is in an unilluminated state, if the triggering instruction is received, the biometric sensor may be activated, where the triggering instruction may indicate a sliding operation of the display relative to the main body; and biometric information may be collected using the collection area corresponding to the biometric sensor.

When the display is in an unilluminated state, if a triggering instruction is received, e.g., the display has slid relative to the main body, the biometric sensor may be activated, e.g., activating the biometric sensor by the triggering instruction. Subsequently, the biometric sensor may be used to collect biometric information. If the biometric information is collected, the display may be illuminated; alternatively, if the biometric information is not collected, the display may remain in the unilluminated state. For example, the biometric sensor may be activated when the display has slid relative to the main body. At this point, the display is still in the unilluminated state and the biometric information is not collected during the sliding operation to avoid the problem of high power consumption caused by the biometric sensor being constantly in the activated state.

Further, if the display is a full display, e.g., the display may have a display area with no other sensors, such as a camera and a fingerprint sensor, which may be disposed on the uppers surface of the main body under the display, and a triggering instruction is received, e.g., the display has slid relative to the main body, the lens of the camera and the fingerprint sensor, which may be the biometric sensor, may be exposed. With the sliding operation of the display relative to the main body, the biometric sensor may be activated to avoid the problem of high power consumption caused by the biometric sensor being constantly in the activated state.

Further, when the triggering instruction is received, e.g., the display has slid relative to the main body, the biometric sensor may be activated to start collecting biometric information. If biometric information is collected, the display may be illuminated; and, if biometric information is not collected, the display may remain unilluminated. Furthermore, if biometric information is collected, the display may be illuminated, at the same time, the biometric information collected may be used to match the pre-store unlock information, If there is a match, the display may be unlocked, otherwise, the display may be illuminated without being unlocked.

Regarding the pre-stored unlock information, if the biometric sensor is a fingerprint sensor, the pre-stored unlock information may be the pre-stored fingerprint information of a user who may have the access to unlock the electronic device. In some embodiments, the pre-stored unlock information may also include the fingerprint information of a plurality of users, a plurality of pieces of fingerprint information of one user, or a plurality of pieces of fingerprint information of each user of the plurality of users.

Furthermore, if the biometric sensor is a camera, the pre-stored unlock information may be the pre-stored face information of a user who may have the access to unlock the electronic device. In addition, the pre-stored unlock information may be other information of the user who may have the access to unlock the electronic device, such as the fingerprints information, the eye information, etc.

In one embodiment, determining whether the biometric information collected by the biometric sensor matches the pre-stored unlock information may be the determination of whether the biometric information is successfully recognized, such as whether the fingerprint is successfully recognized, or whether the image information is successfully recognized, etc.

In one embodiment, when the display is in an unilluminated state, if an activation instruction is received, the biometric sensor may be activated, where the activation instruction may be an indication that the electronic device has received a specific input operation.

In one embodiment, the activation instruction is first received to activate the biometric sensor. At this point, the biometric sensor is in an activated state, but does not collect information. Before the activation instruction is received, the biometric sensor may remain in a sleep or shut off state, until it is activated by the activation instruction. When the triggering instruction is received, the biometric sensor in the activated state may start to collect the biometric information. That is, the activation instruction is first received to activate the biometric sensor. Subsequently, when the display has slid relative to the main body, the biometric sensor may start to collect biometric information. If biometric information is collected, the display may be illuminated in the unilluminated state; alternatively, if biometric information is not collected, the display may remain unilluminated.

Further, the activation instruction may be a detection signal transmitted by a gyro sensor.

The gyro sensor in the electronic device is constantly in an activated state. If the detection signal of the gyro sensor indicates that the electronic device has been picked up or its geospatial state has changed, an activation instruction may be transmitted to activate the biometric sensor, so that the biometric information may be collected by the activated biometric sensor when the electronic device receives the triggering instruction. If the biometric information is collected, the display may be illuminated in the unilluminated state, and if the biometric sensor does not collect the biometric information, the display may remain unilluminated.

In the present embodiment, the biometric sensor may be activated when the activation instruction is received. Before the activation instruction is received, the biometric sensor may remain in a sleep or shut off state, and the gyro sensor may be constantly in an activated state. Since the power consumption of the gyro sensor in the activated state is lower than the power consumption of the biometric sensor in the activated state, the arrangement of the present embodiment may lower the power consumption of the biometric sensor being in a constant activated state.

Further, the activation instruction may be a detection signal transmitted by a P-sensor, or a detection signal transmitted by an acceleration sensor instead of the detection signal transmitted by the gyro sensor.

In some embodiments, the power consumption of the P-sensor may be calculated as follow:

1.8V*0.03 mA+3.3V*0.0007 mA=0.056 mW

In some embodiments, an example power consumption look-up table of the acceleration sensor is provided in Table 1:

TABLE 1

| Symbol | Parameter | Test conditions | Min. | Typ.⁽¹⁾ | Max. | Unit |
|---|---|---|---|---|---|---|
| Vdd | Supply voltage | | 1.71 | 1.8 | 3.6 | V |
| Vdd_IO | Power supply for I/O | | 1.62 | | Vdd + 0.1 | V |
| IddHP | Gyroscope and accelerometer in | up to ODR = 1.6 kHz | | 1.25 | | mA |
| | high-performance mode | | | | | |
| IddNM | Gyroscope and accelerometer in | ODR = 208 Hz | | 0.9 | | mA |
| | normal mode | | | | | |
| IddLP | Gyroscope and accelerometer in | ODR = 13 Hz | | 0.42 | | mA |
| | low-power mode | | | | | |
| LA_IddHP | Accelerometer current consumption | up to ODR = 1.6 kHz | | 240 | | μA |
| | in high-performance mode | | | | | |
| LA_IddNM | Accelerometer current consumption | ODR = 104 Hz | | 70 | | μA |
| | in normal mode | | | | | |
| LA_IddLM | Accelerometer current consumption | ODR = 13 Hz | | 24 | | μA |
| | in low-power mode | | | | | |
| IddPD | Gyroscope and accelerometer in | | | 6 | | μA |
| | power down | | | | | |
| Top | Operating temperature range | | −40 | | +85 | ° C. |

The power consumption of the acceleration sensor may be calculated as follow:

1.8V*0.024 mA=0.043 mW

The power consumption of the fingerprint sensor may be calculated as follow:

1.8V*1.2 mA=2.16 mW

Comparing the above power consumption values, it is clear that both the power consumptions of the P-sensor and the acceleration sensor are lower than the power consumption of the fingerprint sensor. Since the power consumption of the P-sensor, acceleration sensor, or the gyro sensor in the constant activated state is lower than the power consumption of the fingerprint sensor in the constant activated state, in some embodiments, the P-sensor, acceleration sensor, or the gyro sensor is used to transmit the activation instruction over the fingerprint sensor.

Further, the biometric sensor may be disposed under the display, and it may correspond to a partial region on the display. If the biometric sensor is activated, the partial region may be illuminated, where the rest of the display other than the partial region may remain unilluminated.

The biometric sensor may be disposed under the display, and it may correspond to a partial region on the display, e.g., the biometric sensor may be disposed under the display, and a region on the display that corresponds to the biometric sensor may be the partial region.

Further, the partial region may be a partial area on the display that corresponds to a fingerprint sensor composed of one fingerprint recognition chip, in this case, the partial region may be small. Furthermore, the partial area on the display that corresponds to a fingerprint sensor having two or more fingerprint recognition chips, in this case, the partial region may be larger than the partial region composed on a single fingerprint recognition chip.

In the present embodiment, when the biometric sensor is activated, the partial region on the display may be illuminated, e.g., the area on the display where the biometric sensor for detecting the input signal may be illuminated, and the rest of the display other than the partial region may remain unilluminated, that is, not the entire display may be illuminated. When illuminating the partial region, the display will change from an unilluminated state to a partially illuminated state, and the user may be prompted to perform the fingerprint recognition at the partial region. The illumination of the partial region serves the purpose of reminding the user the location of the biometric sensor and to perform the fingerprint recognition, hence, avoiding the problem of not knowing the location to perform the fingerprint recognition, which greatly enhances the user experience.

Further, the partial region may not be illuminated after the biometric sensor is activated as long as the user is aware of the specific area where the biometric sensor is disposed under the display. Without illuminating the display, the privacy of the user using the electronic device is protected, and the user experience is improved.

In one embodiment, if a triggering instruction is receive and the biometric sensor used to collect biometric information collects an input, the display may be illuminated in the unilluminated state. Further, if the triggering instruction is receive and the biometric sensor collects the input, the rest of the display other than the partial region may be illuminated. Furthermore, if the triggering instruction is receive and the biometric sensor does not collect the input, the partial region of the display may be shut off and the rest of the display other than the partial region may remain illuminated.

To serve the purpose of reminding users the area on the display where information should be entered, if the biometric sensor is activated, regardless of when the biometric sensor is activated, or whether the biometric sensor is activated by a trigger instruction or an activation instruction, as soon as it is activated, the partial region on the display may be illuminated, so the user clearly knows the area on the display where information should be entered when entering the information.

If the trigger instruction is received and the biometric sensor collects the input information, the area on the display other than the partial region may be illuminated. At this time, since the partial region is illuminated, and the area on the display other than the partial region is also illuminated, then the entire display is illuminated, that is, the purpose of illuminating the display is achieved.

If the triggering instruction is received and the biometric sensor does not collect the input information, the partial region on the display may be shut off. When the biometric sensor is activated, a partial area on the display corresponding to the biometric sensor may be activated so the user may conveniently enter the biometric information in the partial area on the display, thereby achieving the purpose of illuminating the entire display. However, if the biometric sensor does not collect the input information, then the entire display should not be illuminated. Therefore, at this point, the area on the display other than the partial region may remain unilluminated, and the partial area that is illuminated may be shut off, so the entire display may remain unilluminated.

Further, the display may perform a sliding operation relative to the main body, and the sliding operation may include the display sliding up relative to the main body, and the display sliding down relative to the main body.

Furthermore, the partial region may be a partial area on the display that corresponds to a fingerprint sensor composed of two or more fingerprint recognition chips.

More specifically, different sliding operations and in different parts of the partial region may corresponds to different control instructions. For example, the biometric sensor may be activated and the partial region may be illuminated, if a first triggering instruction is received, e.g., the display has slid up relative to the main body, and the biometric sensor detects an input signal in a first location of the partial region, then the electronic device may execute a third operation, which not only include illuminating the rest of display other than the partial region, but also include activating a third application, such as activating WeChat. In another example, the biometric sensor may be activated and the partial region may be illuminated, if a second triggering instruction is received, e.g., the display has slid up relative to the main body, and the biometric sensor detects an input signal in a second location of the partial region, then the electronic device may execute a fourth operation, which not only include illuminating the rest of display other than the partial region, but also include activating a fourth application, such as activating QQ.

Further, in yet another example, the biometric sensor may be activated and the partial region may be illuminated, if a third triggering instruction is received, e.g., the display has slid down relative to the main body, and the biometric sensor detects an input signal in the first location of the partial region, then the electronic device may execute a fifth operation, which not only include illuminating the rest of display other than the partial region, but also include activating a fifth application, such as activating a music player. In another example, the biometric sensor may be activated and the partial region may be illuminated, if the first triggering instruction is received, e.g., the display has slid down relative to the main body, and the biometric sensor detects an input signal in the second location of the partial region, then the electronic device may execute a sixth operation, which not only include illuminating the rest of display other than the partial region, but also include activating a sixth application, such as activating a video player.

As mentioned above, different sliding operations and the input signal detected in different parts of the partial region may correspond to different control instructions. The examples provided above are merely for illustrative purposes, and other examples may also be included, which are not specifically limited herein.

The embodiments of the present disclosure provide an electronic device that may determine whether to illuminate a display in an unilluminated state based on biometric information in response to the display being in an unilluminated state and a triggering instruction is received, where the triggering instruction may indicate a sliding operation of the display relative to a main body. When the triggering instruction is received, e.g., the display has slid relative to the main body, the biometric information may be used to determine whether to illuminate the display, so that when the display is illuminated, not only the triggering instruction is required, but the biometric information is also required. This process not only ensures the security of the information stored in the electronic device, but also simplifies the use of the electronic device, thereby improving the user experience.

Those skilled in the art may clearly understand that, for ease and concision of the descriptions, the aforementioned processing method may be applied to the related electronic devices, and the related details may refer to corresponding descriptions in the disclosed embodiments, which are not repeated herein.

The embodiments in this specification are described in a progressive manner, each embodiment emphasizes a difference from the other embodiments, and the identical or similar parts between the embodiments may be made reference to each other. Since the apparatuses disclosed in the embodiments are corresponding to the methods disclosed in the embodiments, the description of the apparatuses is simple and relevant parts may be made reference to the description of the methods.

Persons skilled in the art may further realize that, units and steps of algorithms according to the description of the embodiments disclosed by the present disclosure can be implemented by electronic hardware, computer software, or a combination of the two. In order to describe interchangeability of hardware and software clearly, compositions and steps of the embodiments are generally described according to functions in the forgoing description. Whether these functions are executed by hardware or software depends upon specific applications and design constraints of the technical solutions. Persons skilled in the art may use different methods for each specific application to implement the described functions, and such implementation should not be construed as a departure from the scope of the present disclosure.

The methods or algorithms described in the embodiments of the present disclosure may be implemented by hardware, software modules executed by the processor, or a combination of both. The software module can be placed in a random access memory (RAM), memory, read only memory (ROM), electrically programmable ROM, electrically erasable and programmable ROM, register, hard disk, mobile disk, CD-ROM, or any other form of storage medium known to the technical domain.

It will be understood by those skilled in the art that the features described in the respective embodiments and/or claims of the present disclosure can be combined in various ways, even if such combinations are not explicitly described in the present disclosure. In particular, without departing from the spirit and teaching of the present disclosure, the features described in the respective embodiments and/or claims can be combined in various ways. All of these combinations fall within the scope of the present disclosure.

While the present disclosure has been shown and described with reference to various embodiments thereof, it will be understood by those skilled in the art that various modifications in form and details may be made without departing from the spirit and scope of the present disclosure. Therefore, the scope of the present disclosure should not be limited to the above-described embodiments.

It should be noted that the description of the foregoing embodiments of the electronic device may be similar to that of the foregoing method embodiments, and the device embodiments have the same beneficial effects as those of the method embodiments. Therefore, details may not be described herein again. For technical details not disclosed in the embodiments of the electronic device of the present disclosure, those skilled in the art may understand according to the method embodiments of the present disclosure.

In the several embodiments provided in the present disclosure, it should be understood that the disclosed device and method may be realized in other manners. The device embodiments described above are merely examples. All functional modules or units in the embodiments of the present disclosure may all be integrated in one processing unit, or each unit may be used as a single unit. Two or more units may be integrated in one. The above integrated unit can either be implemented in the form of hardware, or in the form of hardware combined with software functional units.

Persons of ordinary skill in the art should understand that, all or a part of steps of implementing the foregoing method embodiments may be implemented by related hardware of an computer instruction program. The instruction program may be stored in a computer-readable storage medium, and when executed, a processor executes the steps of the above method embodiments as stated above. The foregoing storage medium may include various types of storage media, such as a removable storage device, a read only memory (ROM), a random-access memory (RAM), a magnetic disk, or any media that stores program code.

Alternatively, when the above-mentioned integrated units of the present disclosure are implemented in the form of a software functional module being sold or used as an independent product, the integrated unit may also be stored in a computer-readable storage medium. Based on this understanding, the technical solutions provided by the embodiments of the present disclosure essentially or partially may be embodied in the form of a software product stored in a storage medium. The storage medium stores instructions which are executed by a computer device (which may be a personal computer, a server, a network device, or the like) to realize all or a part of the embodiments of the present disclosure. The above-mentioned storage medium may include various media capable of storing program codes, such as a removable storage device, a read only memory (ROM), a random-access memory (RAM), a magnetic disk, or an optical disk.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

The foregoing descriptions only illustrate some embodiments of the present disclosure, and the protection scope of the present disclosure is not limited thereto. The scope that anyone skilled in the art may easily conceive changes and substitutions within the technical scope disclosed in the present disclosure that should be covered by the present disclosure. Therefore, the protection scope of the present disclosure should be subject to the scope of the claims as listed in the following.

What is claimed is:

1. A processing method comprising:
receiving a triggering instruction, the triggering instruction indicating a sliding operation via a touch display; and
determining whether to illuminate the touch display from an unilluminated state based on biometric information in response to the triggering instruction being received.

2. The method according to claim 1, further comprising:
maintaining the touch display in the unilluminated state in response to the triggering instruction being received but a biometric sensor used to collect the biometric information is in a non-working state.

3. The method according to claim 1, further comprising
illuminating the touch display in response to receiving the triggering instruction and the biometric sensor collecting input information, the input information being data indicating the biometric information; and
maintaining the touch display in the unilluminated state in response to receiving the triggering instruction and the biometric sensor not collecting the input information.

4. The method according to claim 3, further comprising
activating the biometric sensor in response to the triggering instruction being received, a collection area corresponding to the biometric sensor being configured to collect the biometric information; or
activating the biometric sensor in response to an activation instruction being received, the activation instruction indicating that an electronic device has received an input operation.

5. The method according to claim 4,
wherein the biometric sensor is disposed under the touch display, and the biometric sensor corresponds to a partial region of the touch display;
the method further comprising:
illuminating the partial region in response to activating the biometric sensor, and maintaining area other than the partial region in the unilluminated state.

6. The method according to claim 5, wherein:
illuminating the touch display in response to receiving the triggering instruction and the biometric sensor collecting the input information includes illuminating the area other than the partial region in response to receiving the triggering instruction and the biometric sensor collecting the input information; and
maintaining the touch display in the unilluminated state in response to receiving the triggering instruction and the biometric sensor not collecting the input information includes turning off the partial region in response to receiving the triggering instruction and the biometric sensor not collecting the input information, and maintaining the area other than the partial region in the unilluminated state.

7. An electronic device comprising:
a touch display; and
a processor configured to:
receive a triggering instruction, the triggering instruction indicating a sliding operation via the touch display; and
determine whether to illuminate the display from an unilluminated state based on biometric information in response to the triggering instruction being received

8. The electronic device of claim 7, further comprising:
a biometric sensor configured to collect the biometric information;
wherein the processor is further configured to:
illuminate the touch display in response to receiving the triggering instruction and the biometric sensor collecting input information, the input information being data indicating the biometric information; and
maintain the touch display in the unilluminated state in response to receiving the triggering instruction and the biometric sensor not collecting the input information.

9. The electronic device according to claim 8, wherein the processor is further configured to:
activate the biometric sensor in response to the triggering instruction being received, a collection area corresponding to the biometric sensor being configured to collect the biometric information; or
activate the biometric sensor in response to an activation instruction being received, the activation instruction indicating that an electronic device has received an input operation.

10. The electronic device according to claim 9, wherein:
the biometric sensor is disposed under the touch display, and the biometric sensor corresponds to a partial region of the touch display; and
the processor is further configured to:
illuminate the partial region in response to activating the biometric sensor, and maintain area other than the partial region in the unilluminated state.
